(19) United States
(12) Patent Application Publication
(10) Pub. No.: US 2010/0228652 A1
(43) Pub. Date: Sep. 9, 2010

(54) BILLING MECHANISM FOR A MOBILE COMMUNICATION NETWORK

(75) Inventors: Najib Koraichi, Schimmert (NL); Javier Montaner, Zaragoza (ES)

Correspondence Address: International IP Law Group, P.O. BOX 691927, HOUSTON, TX, 77269-1927, US

(73) Assignee: Vodafone Holding GmbH, Dusseldorf (DE)

(21) Appl. No.: 12/717,388

(22) Filed: Mar. 4, 2010

(30) Foreign Application Priority Data
Mar. 6, 2009 (EP) 09003274.9-1246

(51) Int. Cl. G06Q 20/00; H04W 4/14; G06Q 30/00; G06Q 50/00

(52) U.S. Cl. 705/34; 455/466; 705/44

(57) ABSTRACT

There is provided a method for charging a user of a mobile communication device connected to a communication network. An exemplary method comprises detecting a predetermined trigger event in a trigger unit of the mobile communication device. The exemplary method also comprises detecting the predetermined event. In response to the detection of the predetermined event, a consent message is generated in a message generating unit of the mobile communication device. The consent message is sent to the communication network, the receipt of the consent message prompting a payment process.

### CROSS REFERENCE TO RELATED APPLICATION

This application claims priority to European (EP) Patent Application No. 09 003 274.9-1246, filed on Mar. 9, 2009, the contents of which are incorporated by reference as if set forth in their entirety herein.

### BACKGROUND

One mechanism for billing users of mobile communication devices for utilizing services with costs is the premium SMS (PSMS) mechanism, which is described in U.S. Patent Application Publication No. 2006/0149644, for example. The PSMS mechanism is based on the Short Message Service (SMS) provided in mobile communication networks and allows for accounting for services, such as, for example, services for providing traffic information, weather information, sports scores or the like on a mobile communication device or for services for downloading audio files, such as, ring tones, or small applications to a mobile communication device. The service or contents to be downloaded within the service may be ordered via a call or a message sent from a mobile communication device to the service provider. Likewise the service may be offered via a webpage that can be accessed using the mobile communication device.

In the PSMS mechanism, the user is charged a predetermined fee for sending or receiving a SMS message. If the charge is made to the sender of the SMS message, the message may be referred to as mobile originating premium SMS (MO-PSMS) message. A MO-PSMS message is to be sent to a predetermined telephone number and includes a predetermined content, such as, for example, a keyword given by a service provider. Depending on the mode of payment the user has chosen, charges for MO-PSMS messages may appear on the user's mobile telephone bill or may be deducted from a pre-paid balance.

If the charge is made to a recipient of the SMS message, the message is be referred to as mobile terminating premiums SMS (MT-PSMS) message. Since the SMS billing presently requires the user's consent to the billing process, the user has to “opt-in” and to initiate the billing process. This is usually done by sending a standard SMS message with a specific content to a predetermined telephone number.

From the user's perspective, in the MT-PSMS mechanism and the MO-PSMS mechanism, the billing process is initiated in the same way by sending an SMS message. Thus, in both embodiments, the PSMS mechanism commits the user to compose a message using his mobile communication device. This may be inconvenient for the user. Particularly, when the service with costs is offered via a webpage, it is inconvenient for a user to send a message in addition to the interaction with the service via the webpage.

### SUMMARY

Exemplary embodiments of the present invention relates the field of mobile communications. Particularly, exemplary embodiments relate to a method for charging a user of a mobile communication device connected to a communication network. Furthermore, exemplary embodiments relate to a mobile communication device for connecting to the communication network, the mobile communication device allowing for practicing the method.

Exemplary embodiments of the present invention may provide a billing mechanism, which facilitates a payment that is made using the PSMS mechanism for the user of a mobile communication device.

According to an exemplary embodiment of the invention, a method for charging a user of mobile communication device connected to a communication network is provided. The exemplary method comprises the steps of:
detecting a predetermined trigger event in a trigger unit of the mobile communication device, and,
upon detection of the predetermined event, generating a consent message in a message generating unit of the mobile communication device and sending the consent message to the communication network, the receipt of the consent message prompting a payment process.

According to another exemplary embodiment, a mobile communication device for connecting to a communication network is provided. The mobile communication device comprises:
a message generating unit adapted to generate a consent message and to control the mobile communication device to sent the message to the communication network, the receipt of the consent message prompting a payment process,
a trigger unit coupled to the message generating unit, the trigger unit being adapted to initiate the generation of the consent message in the message generating component, if the trigger unit detects a predetermined trigger event.

In one exemplary embodiment, the consent message prompting the payment process is generated and sent automatically upon the detection of a trigger event. This disburdens the user from composing the consent message and leads to a higher convenience for the user. Furthermore, errors in the consent message are avoided due to the automated generation so that the payment process becomes more reliable.

In an exemplary embodiment of the method and the mobile communication device, the trigger event is detected, when a trigger message is received in mobile communication device.

The transmission of a trigger message to the mobile communication device allows for a simple triggering of the generation of the consent message, in case a third party, such as, for example, a provider of a service with costs or the payment provider, wants to initiate the payment process. The message may be transmitted to the mobile communication device via the communication network. Preferably, the message comprises an SMS message. However, the message can also be transmitted via an IP-based connection, if an IP connection is established to the mobile communication device (IP: Internet Protocol).

In a related embodiment of the method and the mobile communication device, the trigger message is transparently received in the mobile communication device.

Here, the term “transparent” means that the message and/or the process of receiving the message are not visible to the user of the mobile communication device. The transparent reception of the trigger message leads to a better user experience.

The payment process may allow for billing different amounts so that the desired amount is to be specified explicitly. Therefore, in a further exemplary embodiment of the method and the mobile communication device, the trigger message includes first information about the amount to be charged and the information is used by the message generating unit for including second information about the amount in the consent message.

In particular, this embodiment has the advantage that the trigger message is not only used to trigger the payment process but also for specifying the amount due. This may be done explicitly or implicitly—for example, by specifying the service instead of the amount.

Advantageously, the transmission of the trigger message is linked to the utilization of a service with costs so that the service charge can be settled at the time when the user utilizes the service. Therefore, in one exemplary embodiment of the method and the mobile communication device, the trigger message is sent by a server unit connectable to the mobile communication device via a network connection, when the user of the mobile communication device utilizes a service with costs.

In one exemplary embodiment of the method and the mobile communication device, the trigger unit validates an authenticity of the trigger message using a cryptographic feature of the trigger message.

In this exemplary embodiment, the security of the payment process is increased. Particularly, unauthorized third parties are prevented from fraudulently initiating the payment process by using a trigger message. The cryptographic feature may be a digital signature or another encrypted part of the message and may be validated using a digital certificate.

In addition or as an alternative to the receipt of the trigger message further trigger events can be provided.

Particularly, in one exemplary embodiment of the method and the mobile communication device, the trigger event comprises a receipt of a call in the mobile communication device or an entrance of the mobile communication device in a predetermined radio cell of the communication network.

A definition of the entrance of mobile communication device in a certain radio cell of the (cellular) communication network is especially advantageous in connection with the payment of location-dependent service, such as, for example, the payment of toll collected in a certain geographical region.

In one exemplary embodiment of the method and the mobile communication device, the mobile communication device comprises a mobile terminal and a subscriber identification module and an adapter module is connected between the mobile terminal and the subscriber identification module. The adapter module may comprise the trigger unit and the message generating unit.

The subscriber identification module may be configured as a SIM (Subscriber Identity Module) or as a USIM (Universal Subscriber Identity module).

It is an advantage of the aforementioned exemplary embodiments, that an existing mobile communication device of a user can be retrofitted with the trigger unit and the message generating unit by providing the mobile communication device with the adapter module. Particularly, the user does not have to install software comprising the trigger unit and the message generating unit on his mobile communication device.

In a further exemplary embodiment of the method and the mobile communication device, the message generating unit uses SAT or USAT commands to instruct the mobile terminal to send the consent message to the communication network.

Particularly, the SAT (SIM Application Toolkit) and the USAT (USIM Application Toolkit) provide standard commands for a communication with the mobile terminal via the interface for connecting the subscriber identification module to the mobile terminal. The standard commands allow for an easy implementation of the functionality of the trigger unit and the message generating unit.

Since the adapter module is connected between the mobile terminal and the subscriber identification module, it may also implement the SAT or USAT.

Advantageously, the payment process may be based on the aforementioned PSMS mechanism. Therefore, in one exemplary embodiment of the method and the mobile communication device, the payment process comprises a transmission of a premium SMS message from the mobile communication device to the communication network or from the communication network to the mobile communication device, the transmission of the premium SMS prompting charging the user.

According to one exemplary embodiment of the invention, a payment system is provided. The payment system comprises a mobile communication device of the type described before and a first server connected to communication network. The first server is adapted to receive the consent message and to control the payment process upon receipt of the consent message.

In one exemplary embodiment of the invention, the payment system further comprises a second server connectable with the mobile communication device, the second server being adapted to send a trigger message to the mobile communication device, and the trigger unit is adapted to detect the trigger event, when the trigger message is received in the mobile communication device.

The second server may offer a service with costs and the first server is responsible for accounting of the charges due for the service. In different configurations, the second server and the first server are identical or the second server is different from the first server.

### BRIEF DESCRIPTION OF THE DRAWINGS

Reference will be made by way of example to the accompanying drawings in which

FIG. 1 is a block diagram of a system for billing a user of a mobile communication device, in accordance with an exemplary embodiment of the present invention;

FIG. 2 is a block diagram of a mobile communication device for use in a system according to an exemplary embodiment of the present invention; and

FIG. 3 is a block diagram of a mobile communication device for use in an alternative system according to an exemplary embodiment of the present invention.

### DETAILED DESCRIPTION OF SPECIFIC EMBODIMENTS

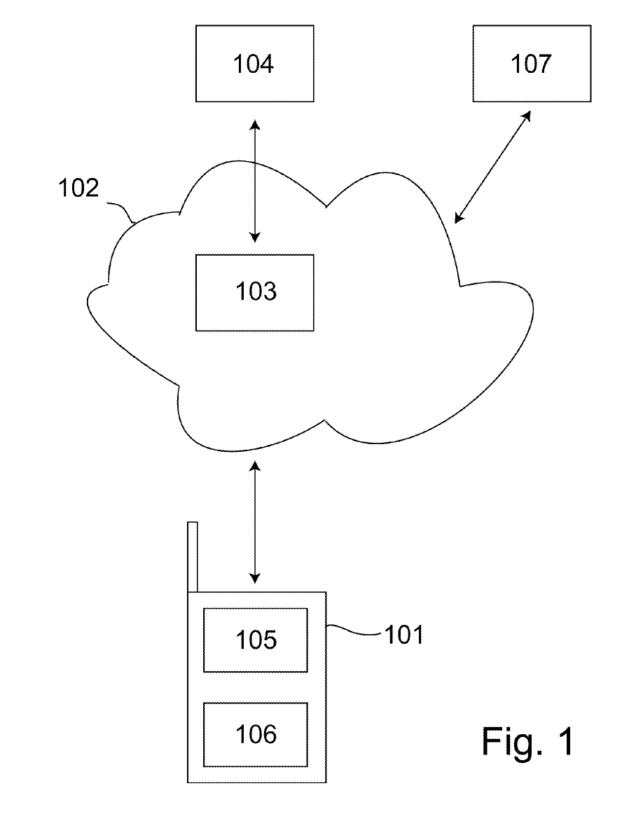

FIG. 1 shows a schematic block diagram of a system for billing a user of a mobile communication device 101. The mobile communication device 101 may be a cellular phone, PDA or the like, and can be connected to the mobile communication network (PLMN) 102 via a radio access network that is not shown in FIG. 1. The PLMN 102 may be configured according to the GSM standard (GSM: Global System for Mobile Communication) or to the UMTS standard (UMTS: Universal Mobile Telecommunications System), for example, and may comprise a circuit switched domain and a packet switched domain. The mobile communication device 101 may access the PLMN 102 via a radio access network that may be configured as GERAN (GSM EDGE Radio Access Network) or UTRAN (UMTS Terrestrial Radio Access Network), for example.

The PLMN 102 provides a short message service (SMS), which, in principle, is known to a person skilled in the art. As common in the art, the SMS uses signaling channels of the PLMN's 102 circuit switched domain to transport messages, such as, for example, the SDCCH (Stand Alone Dedicated Control Channel) or the FACCH (Fast Associated Control Channel). Within the PLMN 102, SMS messages are addressed using an MSISDN (Mobile Subscriber Integrated Services Digital Network Number) of the intended recipient and are forwarded by short message service centers (SMSCs), one of which is shown in FIG. 1 with the reference numeral 103.

The SMSC 103 is connected to a server 104 of a payment provider, which offers a payment service based on the premium SMS (PSMS) mechanism. For this purpose, the server 104 is able to send and/or receive SMS messages. In one exemplary embodiment, the SMSC 103 forwards messages from and to the server 104 as if the server 104 was a mobile device receiving or sending an SMS message. However, it is likewise possible that the server 104 is connected to the SMSC 103 via an IP-based network connection (IP: Internet Protocol). In this exemplary embodiment, the SMSC 103 receives SMS messages addressed to the server 104 and forwards the contents of the message via the IP-based connection. Likewise, the contents of SMS messages sent from the server 104 is passed from the server 104 to the SMSC 103 via the IP-based connection and the SMSC generates the SMS message, which is subsequently transmitted to the recipients via the PLMN 102 using SMS.

The payment provider has contracts with one or more service providers offering services with costs that are paid via the payment provider, or the payment provider offers own services with costs.

In the exemplary embodiment shown in FIG. 1, the service with costs is offered by another server 107, which may be accessible with the mobile communication device 101. A connection between the mobile communication device 101 and the server 107 may be established via the PLMN 102 (as shown in FIG. 1), particularly via the packet switches domain of the PLMN 102, or via another network to which the mobile communication device can be connected. An example of a service with costs, which is accessible via the mobile communication device, is a web-based service for downloading data, such as for example, audio or video files or software applications, to the mobile communication device. In alternative embodiments, the user may access the service with costs in a different way.

In the process of charging the user for utilizing the service, an SMS message, which is referred to as consent message hereinafter, is sent from the mobile communication device 101 to the server 104. The consent message is generated in a message generating component 105 of the mobile communication device 101, after a trigger component 106 has instructed the message generating component 105 to generate the consent message. After having generated the consent message, the message generating component controls the mobile communication device 101 to send the consent message to the server 104 via the interface connecting the mobile communication device 101 with the PLMN 102. The consent message is addressed using the MSISDN assigned to the server 104. This MSISDN may be pre-stored in the message generating component or the MSISDN may be provided in connection with the utilization of service with costs. The provision of the MSISDN will be described in greater detail below.

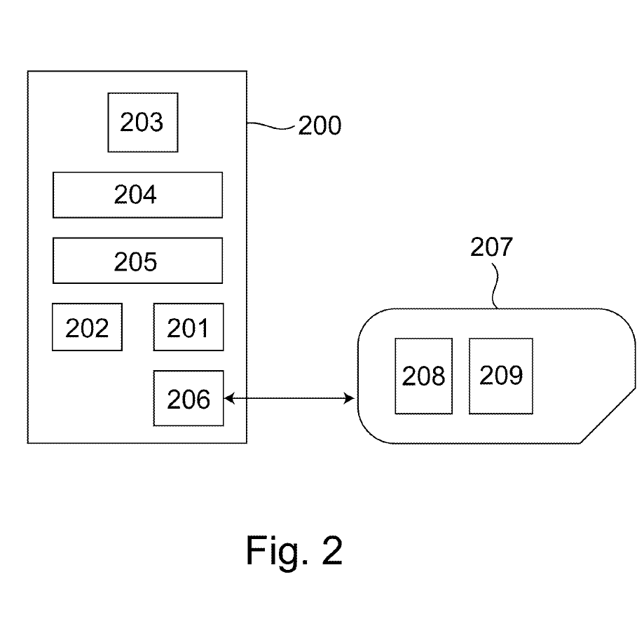

In one exemplary embodiment, the message generating component 105 prompts the user to confirm that the consent message shall be sent. This can be done by presenting an information that a consent will be sent at a display unit 204 of the mobile communication device 101 (see FIG. 2) and by allowing the user to confirm the consent message by actuating an input unit 205 (see FIG. 2) of the mobile communication device. However, if the user gives his consent to the payment in another way—for example, via a webpage—the confirmation can be dispensed with. Therefore, in another exemplary embodiment, no user interaction is required for generating and transmitting the consent message. However, the user may be informed that a consent message has been sent.

As one alternative, a mobile terminating premium SMS (MT-PSMS) mechanism is provided. Here, the consent message is sent to the server 104 at first and the server 104 answers the consent message with a PSMS message that is sent to the mobile communication device 101. The premium SMS message is charged to the user and the charged amount appears on the user's telephone bill. In one exemplary embodiment, the premium SMS is not charged to the user until the SMSC receives a confirmation from the mobile communication device 101 that the premium SMS has been accepted. In this case, the SMSC informs the server 104 about the receipt of the confirmation. The receipt of the confirmation of the acceptance of the premium SMS serves as confirmation of the consent of the user to be charged. However, since the consent of the user yields from the consent message, the mere transmission of the premium SMS could be charged to the user.

In another exemplary embodiment, a mobile originating premium SMS (MO-PSMS) mechanism is provided. In this exemplary embodiment, the consent message sent from the mobile communication device 101 to the server 104 corresponds to the premium SMS message and the receipt of the message in the SMSC or in the server 104 results in the billing of the user. The amount charged to the user may again appear on the user's telephone bill.

In both cases, i.e. in case an MT-PSMS or an MO-PSMS mechanism is provided, the consent message preferably includes a predetermined content specifying that the message is a consent message. The person skilled in the art knows that SMS messages like the consent message usually comprise a header and a body. The predetermined content may be a keyword in the body of the message and/or predetermined information in the header of the message. If services with different costs are provided, the consent message also specifies the service or the amount due for utilizing the service. Again, this may be done by using a predetermined keyword in the body or the header of the consent message, which allows the server 104—or the SMSC 103, if the amount is determined in the SMSC 103—to determine the amount that is to be charged to the user. The keyword is selected from a plurality of keywords by the trigger component 105, or the keyword is provided to the mobile communication device 101 in connection with the utilization of the service, as it will be described below.

The trigger component 106 of the mobile communication device 101 controls the message generating component 105 to generate the consent message, when a predetermined event, which is referred to as trigger event hereinafter, is detected in the trigger component. The event can be realized by the trigger component 106 itself or by another component of the mobile communication device 101 that signalizes the occurrence of the event to the trigger component 106.

In principle, any event that can be realized in the mobile communication device 101 can be a trigger event leading to the generation and sending of the consent message.

In particular, the trigger event may be the receipt of a predetermined message, which is referred to as trigger message hereinafter. The trigger message may be an SMS message sent to the mobile communication device 101 by the server 104 of the payment provider or by the server 107 of the service provider. As an alternative, the trigger message may be sent via an existing IP connection between server 104 or the server 107 and the mobile communication device 101. Particularly, this is practicable, if the user access the server 107 providing the service with costs via an IP connection. Preferably, the trigger message is addressed directly to the trigger component 106 in such a way that it is forwarded to the trigger component 105 without presenting the message to the user.

The trigger message includes a predetermined content that allows the trigger component 106 to identify the message as trigger message. Moreover, the trigger message specifies the MSISDN assigned the server 104 in case this MSISDN is not stored in the message generating component 105. Furthermore, the trigger message may identify the service or the amount due for utilizing the service, if several services with different costs are provided. In particular, the trigger message may comprise the keyword that is assigned to the service or the amount. If the MSISDN assigned to the server 104 and/or information identifying the amount due for utilizing the service are included in the trigger message, the trigger component 106 reads out these data and passes them to the message generating component 105, which uses the information to generate the consent message.

In order to prevent fraudulent use, the trigger message may contain a cryptographic security feature that has to be verified successfully in the trigger component 106 before the trigger component 106 instructs the message generating component 105 to generate the consent message. The security feature may be a digital signature or another encrypted part of the trigger message that is verified using a digital certificate. The digital certificate may be issued by the payment provider and securely stored in the mobile communication device 101.

Another possible trigger event is a call received in the mobile communication device 101 from a predetermined caller MSISDN. The call may be initiated automatically by server 104 of the payment provider or by the server 107 of the service provider, when the user utilizes a service with costs.

The aforementioned trigger events, i.e. the receipt of a trigger message or a call, are especially suitable for triggering the payment process in case the user interacts with the server 107 of the service provider, when utilizing the service. In particular, this may be the case if the service allows the user to download data to the mobile communication device 101. Here, the trigger message can be sent to the mobile communication device 101 or the call can be initiated, when the user orders the data to be downloaded and gives his consent to the payment of the charge due for the download. In this exemplary embodiment, a confirmation of the user for sending the consent message can be dispensed with, since the user has given his consent with the order.

Another example of a trigger event that can be detected in the mobile communication device 101 is the entrance of the mobile communication device 101 in a certain cell of the cellular radio access network. In a cellular radio access network, a unique cell ID (Identification) is assigned to each cell and the identification is broadcasted within the cell. Thus, the trigger component 105 can control the message generating component 106 to generate and send the consent message when a predetermined cell ID is received for the first time. The predetermined cell ID may be stored in the trigger component 106.

Using the entrance of the mobile communication device 101 into a certain cell as a trigger event is especially advantageous in connection with location dependent services. One example of such a service is the payment of toll collected in a certain region. Here, the trigger component 106 can instruct the message generating component 105 to generate and send the consent message when the mobile communication device 101 enters a cell of the radio access network, which belongs to the region where the toll is collected.

In FIG. 2, a block diagram of the mobile communication device 101 in one exemplary embodiment is schematically depicted.

The mobile communication device 101 comprises a mobile terminal 200 including a main processor 201 for controlling the operation of the mobile terminal 200. A memory unit 202 is coupled to the main processor 201 for storing data and applications that can be run on the main processor 201. The mobile terminal 200 comprises one or more communication interfaces for establishing data connections. Particularly, the mobile terminal 200 provides a radio interface 203 for connecting the mobile terminal 200 wirelessly to the PLMN 102 via the radio access network. Furthermore, the mobile terminal 200 comprises a display unit 204 and an input unit 205, which can be operated by the user of the mobile communication device 101. The input unit 205 may be configured as a keypad and/or a touch screen that also forms the display unit 204.

Via a card reader unit 206, the mobile terminal 200 can be connected to a subscriber identification module 207 to form the mobile communication device 101. The subscriber identification module 207 is a so-called smart card, which can be inserted into a card receptacle of the mobile terminal 200 that holds the card in a position, in which its contact elements are connected to corresponding contact elements of the card reader unit 206 of the mobile terminal 200. The card receptacle and the card reader unit 206 are usually arranged within a battery compartment of the mobile terminal 200, which is accessible by the user of the mobile communication device 101.

According the type of the PLMN 102, the subscriber identification module 207 may be configured as a subscriber identity module (SIM) according to the GSM standard or as a universal subscriber identity module (USIM) according to the UMTS standard, for example. It comprises a microprocessor 208 and a non-volatile memory 209 and stores pre-configured user-related and network-related data, particularly data identifying the user and data for authenticating the user or his mobile communication device 101 to the cellular mobile network 102. Moreover, it may store personal data of the user and additional applications run on the microprocessor 208.

In one exemplary embodiment, the message generating component 105 and trigger component 106 are configured as software applications run on the main processor 201 of the mobile terminal 200. The software code may be stored in the memory unit 202 of the mobile terminal.

In another exemplary embodiment, the message generating component 105 and the trigger component 106 are configured as a software application run on the microprocessor 208 of the subscriber identification module 207. Here, the corresponding software code may be stored in the memory 209 of the subscriber identification module 207.

For communicating with the mobile terminal 200, the software may implement commands of the SIM application toolkit (SAT) specified in the specification GSM 11.14 of the 3rd generation project partnership (3GPP) if the subscriber identification module 207 is a SIM according the GSM standard or the adapter module 301 may implement the USIM application toolkit (USAT) specified in the specification TS 31.111 of the 3GPP if the subscriber identification module 207 is a USIM. The SAT or USAT allows applications run in the subscriber identification module 207 to access functions of the mobile terminal 200 and particularly comprises so-called proactive commands that may be used by the subscriber identification module 207 to access the functions of the mobile terminal 200 on its own initiative.

In particular, the message generating component 105 may use proactive (U)SAT commands to instruct the mobile terminal 200 to send the consent message generated in the message generating component 106 to the PLMN 102. If it is provided that the trigger component is responsive to a trigger message sent to the mobile communication device 101, (U)SAT commands can be used to instruct the mobile terminal 200 to forward the trigger message transparently to the trigger component 106 in the subscriber identification module 207.

Due to the possibility to use standardized (U)SAT commands, it is easier to implement the functionalities of the message generating component 105 and the trigger component 106 in the subscriber identification module 207 than in the mobile terminal 200, because the internal interfaces in the mobile terminal 200 are predominantly not standardized so the no standardized commands can be used.

In both exemplary embodiments described before, i.e. if the message generating component 105 and trigger component 106 are configured as software modules run in the mobile terminal 200 or in the subscriber identification module 207, the message generating component 105 and the trigger component 106 can be retrofitted in the mobile communication device 101. For this purpose, the software can be provided to the user via the Internet or in another way, and the user can install the software in the mobile terminal 200 or in the subscriber identification module 207. For installing the software modules in the subscriber identification module 207, it is also possible to use the so-called over the air (OTA) technology as described, for example, in ETSI TS 102 225 and in 3GPP TS 23.048, which allows for updating or changing data and/or applications in the subscriber identification module 207.

However, in the subscriber identification module 207 software can only be installed, if the installation is authorized by the operator of the PLMN 102. Usually, the software code has to be encrypted using a key, which is shared between the network operator and the subscriber identification module 207. The subscriber identification module 207 decrypts the code using a corresponding decryption key thereby confirming that the code originates from the network operator or the installation is authorized by the network operator. Thus, it is not possible for a payment provider to provide the software modules to the user without involving the network operator.

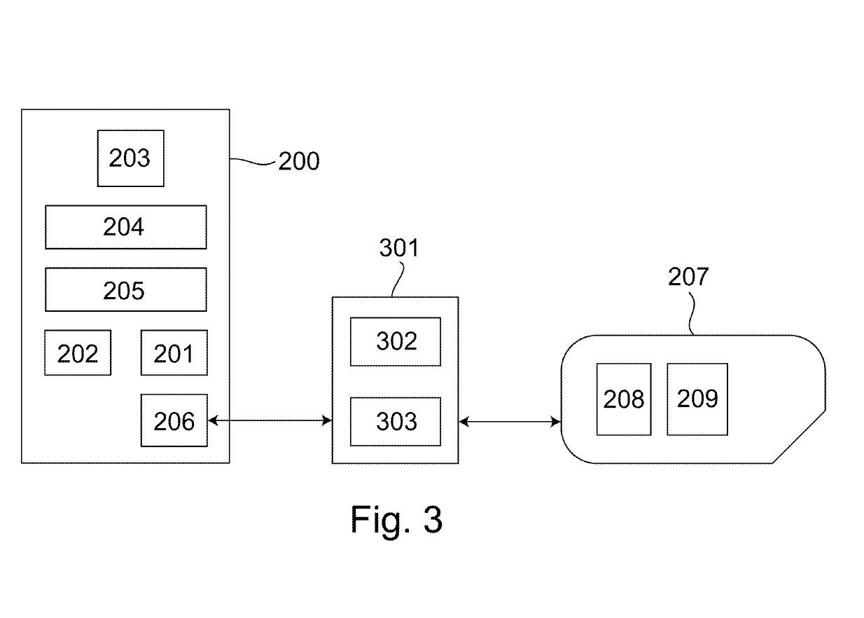

In FIG. 3, another exemplary embodiment of the mobile communication device 101 is depicted in a schematic block diagram. The mobile communication device 101 comprises a mobile terminal 200 and a subscriber identification module 207, which are configured in the same way as described before. The exemplary embodiment shown in FIG. 3 differs from the exemplary embodiment of the mobile communication device 101 shown in FIG. 2 in that the subscriber identification module 207 is not connected directly to the mobile terminal 200 or its card reader unit 206, but via an adapter module 301.

The adapter module 301 comprises a microprocessor 302 and a memory unit 303 for storing data and applications that can be run on the microprocessor 302. The adapter module 301 is connected between the mobile terminal 200 and the subscriber identification module 207 and acts as a so-called man in the middle between the mobile terminal 200 and the subscriber identification module 207. Hence, communication signals between the mobile terminal 200 and the subscriber identification module 207 are exchanged via the adapter module 301.

The adapter module 301 is capable of manipulating or modifying the data exchanged between the mobile terminal 200 and the subscriber identification module 207. Moreover, the adapter module 301 is capable of initiating a communication with the mobile terminal 200 to interact proactively with the mobile terminal 200 and with the subscriber identification module 207. For this purpose, the adapter module 301 may implement the SAT, if the subscriber identification module 207 is a SIM according the GSM standard, or the adapter module 301 may implement the USAT, if the subscriber identification module 207 is a USIM. By implementing the SAT or USAT in the adapter module 301, the adapter module 301 is able to access the functions of the mobile terminal 200 in the same way as the subscriber identification module 207.

For connecting the adapter module 301 between the mobile terminal 200 and the subscriber identification module 207, the adapter module 301 comprises a contacting element, which can be inserted into the card receptacle of the mobile terminal 200 and which includes electric contacts for contacting the contact elements of the card reader unit 206. Further electrical contacts are provided for contacting the electric contacts of the subscriber identification module 207. The electric contacts for connecting the adapter module 301 to the mobile terminal 200 and the electric contacts for connecting the adapter module 301 are connected to the microprocessor 302 of the adapter module 301.

As one of the electric contacts of the card reader unit 206 of the mobile terminal 200 acts as a power supply for the subscriber identification module 207, the adapter module 301 can also be supplied with power via this electric contact. Moreover the adapter module 301 is able to forward data received via an electric contact of the card reader unit 206 to the corresponding electric contact of the subscriber identification module 207 and vice versa. The forwarded data may be modified by the microprocessor 302 of the adapter module 301 or the adapter module 301 may leave the data unmodified, thereby allowing a normal communication between the mobile terminal 200 and the subscriber identification module 207. Moreover, proactive commands can be sent from adapter module 301 to the mobile terminal 200 via the electric contact, which are provided for sending commands from the subscriber module 207 to the mobile terminal 200.

In one exemplary embodiment, the adapter module 301 comprises a thin contacting element, which has essentially the same shape as the subscriber identification module 207 and which can be inserted into the card receptacle of the mobile terminal 200 between the electric contacts of the card reader unit 206 and the subscriber identification module 207. On one surface, the contacting element comprises contact elements for contacting the contact elements of the subscriber identification module 207 and on the opposite surface, contact elements are arranged for contacting the contact elements of the card reader unit 206. The contact elements are connected to the microprocessor 302 of the adapter module 301. The microprocessor 302 and the memory unit 303 of the adapter module 301 may be mounted on a circuit board, which is connected to the contacting element by a flexible wire, thereby allowing placing the circuit board into the battery compartment of the mobile terminal 200 together with the battery. As an alternative, the microprocessor 302 and the memory unit 303 may be included in a chip that is mounted on the contacting element. In this exemplary embodiment, the subscriber identification module 207 is being provided with a cutting for accepting the chip.

In another exemplary embodiment, the adapter module 301 comprises a contacting element that has essentially the same shape and thickness as the subscriber identification module 207 and that can be inserted into the card receptacle of the mobile terminal 200 to contact the contact elements of the card reader unit 206. The contacting element is connected to a circuit board via one or more flexible wires. The microprocessor 302 and the memory unit 303 are mounted on the circuit board and in addition, the circuit board comprises a card reader unit connected to the microprocessor 302 for receiving the adapter module 301 to the subscriber identification module 207. The circuit board may be thin enough to place it into the battery compartment of the mobile terminal 200.

The message generating component 105 and the trigger component 106 are configured as software modules that are run on the microprocessor 302 of the adapter module 301. The corresponding software code may be stored in the memory unit of the adapter module 301. Due to the configuration of the adapter module 201 described before, the software can interact with the mobile terminal 200 in a similar way as it would do, if the software was installed in the subscriber identification module 207. Particularly, this means that the SAT commands can be used for communicating with the mobile terminal 200, if the subscriber identification module 207 is a SIM or the USAT commands can be used if the subscriber identification module 207 is a USIM. As in the exemplary embodiment providing the installation of the software module in the subscriber identification module 207, the message generating component 105 can use (U)SAT commands to instruct the mobile terminal 200 to send the consent message to the PLMN 102 and (U)SAT commands can be used to instruct the mobile terminal 202 transparently forward a trigger message to the trigger component 106. Thus, the implementation of the message generating component 105 and the trigger component 106 and the adapter module 301 offers essentially the same advantages as the installation of these components in the subscriber identification module 207.

Moreover, an adapter module 301 with a pre-installed message generating component 105 and trigger component 106 can be provided to the user by the payment provider in order to allow the user to retrofit his mobile communication device 101. This can be done by the user by simply inserting the adapter module 301 in his mobile communication device 101 without having to install software in the mobile terminal 200 or in the subscriber identification module 207. An authorization of the network operator is not necessary for using the adapter module 301. From the point of view of the payment provider, this is another advantage of the adapter module 301.

While exemplary embodiments of the invention have been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

What is claimed is:

1. A method for charging a user of a mobile communication device connected to a communication network, the method comprising:
detecting a predetermined trigger event in a trigger unit of the mobile communication device;
detecting the predetermined event;
generating, in response to the detection of the predetermined event, a consent message in a message generating unit of the mobile communication device; and
sending the consent message to the communication network, the receipt of the consent message prompting a payment process.

2. The method recited in claim 1, wherein the trigger event is detected when a trigger message is received in the mobile communication device.

3. The method recited in claim 2, wherein the trigger message is transparently forwarded to the trigger unit.

4. The method recited in claim 1, wherein the trigger message includes first information about the amount to be charged, the information being used by the message generating unit for including second information about the amount in the consent message.

5. The method recited in claim 1, wherein the trigger message is sent by a server unit connectable to the mobile communication device via a network connection, when the user of the mobile communication device uses a service with costs.

6. The method recited in claim 1, wherein the trigger unit validates an authenticity of the trigger message using a cryptographic feature of the trigger message.

7. The method recited in claim 1, wherein the trigger event comprises a receipt of a call in the mobile communication device or an entrance of the mobile communication device in a predetermined radio cell of the communication network.

8. The method recited in claim 1, wherein the mobile communication device comprises a mobile terminal and a subscriber identification module and wherein an adapter module is being connected between the mobile terminal and the subscriber identification module, the adapter module comprising the trigger unit and the message generating unit.

9. The method recited in claim 1, wherein the message generating unit uses SAT or USAT commands to instruct the mobile terminal to send the consent message to the communication network.

10. The method recited in claim 1, wherein the payment process comprises a transmission of a premium SMS message from the mobile communication device to the communication network or from the communication network to the mobile communication device, the transmission of the premium SMS prompting charging the user.

11. A mobile communication device for connecting to a communication network, the mobile communication device comprising:
a message generating unit adapted to generate a consent message and to control the mobile communication device to send the message to the communication network, the receipt of the consent message prompting a payment process; and
a trigger unit coupled to the message generating unit, the trigger unit being adapted to initiate the generation of the consent message in the message generating component, if the trigger unit detects a predetermined trigger event.

12. The mobile communication device recited in claim 11, further comprising a mobile terminal and a subscriber identification module and wherein an adapter module is connected between the mobile terminal and the subscriber identification module, the adapter module comprising the trigger unit and the message generating unit.

13. A payment system comprising:
a mobile communication, for connecting to a communication network, the mobile communication device comprising:
a message generating unit adapted to generate a consent message and to control the mobile communication device to send the message to the communication network, the receipt of the consent message prompting a payment process; and
a trigger unit coupled to the message generating unit, the trigger unit being adapted to initiate the generation of the consent message in the message generating component, if the trigger unit detects a predetermined trigger event; and
a first server connected to the communication network, the first server being adapted to receive the consent message and to control the payment process upon receipt of the consent message.

14. The payment system recited in claim 13, comprising a second server connectable with the mobile communication device, the second server being adapted to send a trigger message to the mobile communication device, wherein the trigger unit is adapted to detect the trigger event, when the trigger message is received in the mobile communication device.
